(19) United States
(12) Patent Application Publication
(10) Pub. No.: US 2017/0123574 A1
(43) Pub. Date: May 4, 2017

(54) SENSOR AND SENSOR-EQUIPPED DISPLAY DEVICE

(71) Applicant: Japan Display Inc., Minato-ku (JP)

(72) Inventor: Yoshinori INAGAKI, Tokyo (JP)

(73) Assignee: Japan Display Inc., Minato-ku (JP)

(21) Appl. No.: 15/336,170

(22) Filed: Oct. 27, 2016

(30) Foreign Application Priority Data
Oct. 30, 2015 (JP) 2015-213830

(51) Int. Cl. G06F 3/041; G06F 3/044

(52) U.S. Cl. CPC G06F 3/0416; G06F 3/0412; G06F 3/044; G09G 3/3648

(57) ABSTRACT

According to one embodiment, a sensor includes a first electrode including a first sensor element and a second sensor element, a second electrode disposed to be spaced apart from the first sensor element and the second sensor element, a connection line including a first line electrically connected to the first sensor element and a second line electrically connected to the second sensor element, a third electrode disposed around an electrode group including the first electrode, the second electrode and the connection line, and a fourth electrode disposed between the third electrode, and at least plural parts of the first sensor element and the first line.

### CROSS-REFERENCE TO RELATED APPLICATIONS

This application is based upon and claims the benefit of priority from Japanese Patent Application No. 2015-213830, filed Oct. 30, 2015, the entire contents of which are incorporated herein by reference.

### FIELD

Embodiments described herein relate generally to a sensor and a sensor-equipped display device.

### BACKGROUND

Recently, sensors capable of detecting contact or approach of an object such as a finger have been put into practical use as a display device interface or the like. As an example of such sensors, a capacitive touch panel comprises an electrode which detects the variation in electrostatic capacitance caused by the object. For example, a sensor array including sensor technology in which a transmit (Tx) electrode and a receive (Rx) electrode are arranged is well known.

In a sensor array having a layout in which a connection line connected to the Rx electrode and the Tx electrode are adjacent to each other, capacitive coupling occurs between the connection line and the Tx electrode. For this reason, the variation in electrostatic capacitance caused by the object may not be properly detected in a detection signal read from the Rx electrode via the connection line, and degradation in the sensitivity of detection may thereby result.

### BRIEF DESCRIPTION OF THE DRAWINGS

FIG. 1 is a perspective view showing a configuration of a display device DSP including a sensor SE of the embodiment.

FIGS. 2A, 2B and 2C are cross-sectional views for explanation of a positional relationship between the display panel PNL and the sensor SE shown in FIG. 1.

FIG. 3 is a diagram showing a basic configuration and an equivalent circuit, of the display panel PNL shown in FIG. 1.

FIG. 4 is an equivalent circuit diagram showing one of pixels PX shown in FIG. 3.

FIG. 5 is a cross-sectional view schematically showing a structure of a part of the display panel PNL shown in FIG. 1.

FIG. 6A is a plan view showing a configuration example of the sensor SE of the embodiment.

FIG. 6B is a plan view showing another configuration example of the sensor SE of the embodiment.

FIG. 7 is a cross-sectional view showing the sensor SE seen along line A-B of FIG. 6A.

FIGS. 8A and 8B are illustrations showing examples of disposition of the fourth electrode E4.

FIG. 9 is a plan view showing yet another configuration example of the sensor SE of the embodiment.

FIG. 10 is a plan view showing yet another configuration example of the sensor SE of the embodiment.

FIG. 11 is a plan view showing yet another configuration example of the sensor SE of the embodiment.

### DETAILED DESCRIPTION

In general, according to one embodiment, a sensor includes: a first electrode including a first sensor element and a second sensor element disposed to be spaced apart from each other; a second electrode disposed to be spaced apart from the first sensor element and the second sensor element; a connection line disposed on a side opposite to the second electrode to sandwich the first electrode, the connection line including a first line electrically connected to the first sensor element and a second line electrically connected to the second sensor element, the first line arranged to be spaced apart from the second sensor element and the second line; a third electrode disposed around an electrode group including the first electrode, the second electrode and the connection line; and a fourth electrode disposed between the third electrode, and at least plural parts of the first sensor element and the first line.

According to another embodiment, a display device includes: a display panel including a display area to display an image; a cover member opposed to the display panel; and a sensor disposed on any one of a side of the display panel opposed to the cover member, an inner side of the display panel, and a side of the cover member opposed to the display panel, the sensor including: a first electrode including a first sensor element and a second sensor element disposed to be spaced apart from each other; a second electrode disposed to be spaced apart from the first sensor element and the second sensor element; a connection line disposed on a side opposite to the second electrode to sandwich the first electrode, the connection line including a first line electrically connected to the first sensor element and a second line electrically connected to the second sensor element, the first line disposed to be spaced apart from the second sensor element and the second line; a third electrode disposed around an electrode group including the first electrode, the second electrode, and the connection line; and a fourth electrode disposed between the third electrode, and at least plural parts of the first sensor element and the first line.

According to yet another embodiment, a sensor includes: a first electrode including a first sensor element and a second sensor element disposed to be spaced apart from each other; a second electrode disposed between the first sensor element and the second sensor element, on a side closer to the first sensor element; a first line disposed on a side opposite to the second electrode to sandwich the first electrode, and electrically connected to the first sensor element; a second line disposed on the side opposite to the second electrode and electrically connected to the second sensor element; a third electrode disposed between the second electrode, and the second sensor element and the second line; and a fourth electrode disposed between the third electrode, and at least plural parts of the second sensor element and the second line.

According to yet another embodiment, a display device includes: a display panel including a display area to display an image; a cover member opposed to the display panel; and a sensor disposed on any one of a side of the display panel opposed to the cover member, an inner side of the display panel, and a side of the cover member opposed to the display panel, the sensor including: a first electrode including a first sensor element and a second sensor element disposed to be spaced apart from each other; a second electrode disposed between the first sensor element and the second sensor element, on a side closer to the first sensor element; a first line disposed on a side opposite to the second electrode to sandwich the first electrode, and electrically connected to the first sensor element; a second line disposed on the side opposite to the second electrode and electrically connected to the second sensor element; a third electrode disposed between the second electrode, and the second sensor element and the second line; and a fourth electrode disposed between the third electrode, and at least plural parts of the second sensor element and the second line.

Embodiments will be described hereinafter with reference to the accompanying drawings. The disclosure is a mere example, and arbitrary change of gist which can be easily conceived by a person of ordinary skill in the art naturally falls within the inventive scope. To more clarify the explanations, the drawings may pictorially show width, thickness, shape and the like of each portion as compared with actual embodiments, but they are mere examples and do not restrict the interpretation of the invention. Furthermore, in the description and Figures of the present application, structural elements having the same or similar functions will be referred to by the same reference numbers and detailed explanations of them that are considered redundant may be omitted.

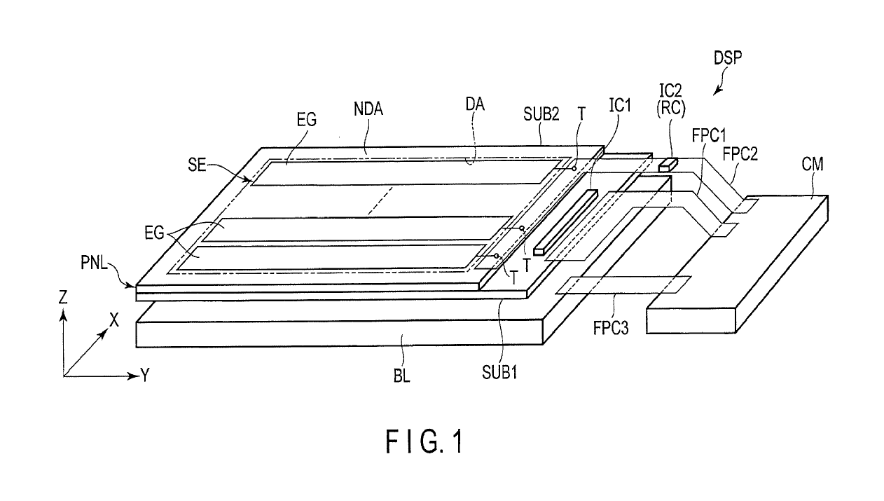

FIG. 1 is a perspective view showing a configuration of a display device DSP including a sensor SE of one of the embodiments. In FIG. 1, first direction X and second direction Y are perpendicular to each other. Third direction Z is orthogonal to each of the first direction X and the second direction Y.

In the embodiment, a liquid crystal display device will be explained as an example of the display device. The display device can be used for, for example, various devices such as a smartphone, a tablet terminal, a mobile telephone terminal, a personal computer, a TV receiver, a vehicle-mounted device, and a game console. The major configuration explained in the embodiment can also be employed in a self-luminous display device including an organic electroluminescent display element and the like, an electronic paper display device including a cataphoretic element and the like, a display device employing micro-electro-mechanical systems (MEMS), or a display device employing electrochromism.

The display device DSP includes a display panel PNL, a driving IC chip IC1 which drives the display panel PNL, a sensor SE, a driving IC chip IC2 which drives the sensor SE, an illuminating unit BL which illuminates the display panel PNL, a control module CM, flexible printed circuits FPC1, FPC2 and FPC3, and the like.

The display panel PNL includes a first substrate SUB1, a second substrate SUB2 opposed to the first substrate SUB1, and a liquid crystal layer held between the first substrate SUB1 and the second substrate SUB2 (i.e., a liquid crystal layer LC which will be described later). The display panel PNL includes a display area DA on which an image is displayed and a frame-shaped non-display area NDA which surrounds the display area DA. The display panel PNL is, for example, a transmissive display panel having a transmissive display function of displaying images by selectively transmitting the light from the illuminating unit BL serving as a backlight unit. The display panel PNL may be a reflective display panel having a reflective display function of displaying images by selectively reflecting the light from the display surface side, such as external light and auxiliary light. In addition, the display panel PNL may be a transflective display panel having the transmissive display function and the reflective display function. If a reflective display panel PNL is used, the illuminating unit BL located on a side opposed to the first substrate SUB1 as illustrated in the drawing is not disposed. However, if a reflective display panel PNL is used, the illuminating unit BL may be disposed as a front light unit on a side opposed to the second substrate SUB2.

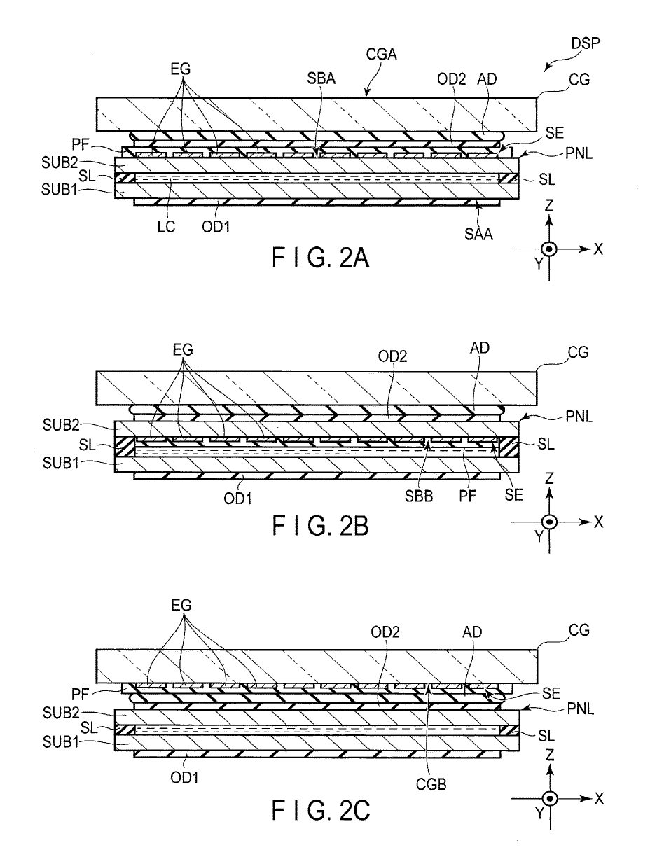

The sensor SE includes electrode groups EG in the display area DA. The electrode groups EG are disposed on the side of, for example, the display surface of the display panel PNL or an outer surface SBA (FIGS. 2A-2C) of the second substrate SUB2 which will be explained later. In the example depicted, the electrode groups EG extend substantially in the second direction Y and are arranged in the first direction X to be spaced apart from each other. The electrode groups EG are electrically connected to terminal portions T located in the non-display area NDA, respectively. Each of the terminal portions T is an assembly of terminals, though not illustrated in detail. The electrode groups EG are not limited to those of the example illustrated, but may extend substantially in the first direction X and arranged to be spaced apart from each other in the second direction Y. The sensor SE includes third and fourth electrodes which will be explained later, and the like, in addition to the electrode groups EG illustrated in FIG. 1.

The driving IC chip IC1 is mounted on the first substrate SUB1 of the display panel PNL. The driving IC chip IC2 is mounted on the flexible printed circuit FPC2. The flexible printed circuit FPC1 which makes connection between the display panel PNL and the control module CM has an end mounted on the first substrate SUB1 and the other end connected to the control module CM. The flexible printed circuit FPC2 which makes connection between the sensor SE and the control module CM has an end mounted on the second substrate SUB2 and is connected to each of the terminal portions T. The other end of the flexible printed circuit FPC2 is connected to the control module CM. The flexible printed circuit FPC3 makes connection between the illuminating unit BL and the control module CM. The other end of the flexible printed circuit FPC2 may not be connected to the control module CM, but may be connected to the flexible printed circuit FPC1 or mounted on the first substrate SUB1. The driving IC chip IC2 may be mounted on the flexible printed circuit FPC1 or may be integrated with the driving IC chip IC1 and mounted on the first substrate SUB1 as one single IC chip.

A detection circuit RC is built in, for example, the driving IC chip IC2. The detection circuit RC has a function of detecting the contact of the object on the sensor SE or approach of the object to the sensor SE and detecting the position where the object has contacted or approached the sensor SE. The detection circuit RC may be accommodated in the control module CM or built in the driving IC chip IC1.

FIGS. 2A-2C are cross-sectional views for explanation of a positional relationship between the display panel PNL and the sensor SE shown in FIG. 1. In the example illustrated, the display device DSP includes a cover member CG opposed to the display panel PNL. The cover member CG is, for example, transparent and formed of glass or a resin material. The cover member CG has an outer surface CGA serving as a surface of detection of the object and an inner surface CGB opposed to the display panel PNL. The sensor SE is configured to detect the object which contacts or approaches the outer surface CGA.

An example shown in FIG. 2A corresponds to an example that the sensor SE is disposed on a side of the display panel PNL which is opposed to the cover member CG. More specifically, the first substrate SUB1 and the second substrate SUB2 are bonded by a sealing member SL, in the display panel PNL. A liquid crystal layer LC is held on an inner side surrounded by the sealing member SL, in a cell gap between the first substrate SUB1 and the second substrate SUB2. The display panel PNL is bonded to the cover member CG by a transparent adhesive AD.

In the example illustrated, the electrode groups EG constituting the sensor SE are formed on an outer surface SBA of the second substrate SUB2 which is opposed to the cover member CG, and are covered with a protective film PF. A first optical element OD1 is disposed on an outer surface SAA of the first substrate SUB1. A second optical element OD2 is disposed on a side of the sensor SE which is opposed to the cover member CG or on the protective film PF.

An example shown in FIG. 2B corresponds to an example that the sensor SE is disposed inside the display panel PNL. In the example illustrated, the electrode groups EG constituting the sensor SE are formed on an inner surface SBB of the second substrate SUB2 which is opposed to the first substrate SUB1, and are covered with the protective film PF. The sensor SE may be formed on the first substrate SUB1. In the examples shown in FIGS. 2A, 2B, the second substrate SUB2 serving as a base of the electrode groups EG corresponds to a support body which supports the sensor SE. However, the other insulating film may be interposed between the second substrate SUB2 and the electrode groups EG as the other support body.

An example shown in FIG. 2C corresponds to an example that the sensor SE is disposed on a side of the cover member CG which is opposed to the display panel PNL. In the example illustrated, the electrode groups EG constituting the sensor SE are formed on the inner surface CGB of the cover member CG which is opposed to the display panel PNL, and are covered with the protective film PF. In the example illustrated, the cover member CG serving as a base of the electrode groups EG corresponds to the support body which supports the sensor SE. However, the other insulating film may be interposed between the cover member CG and the electrode groups EG as the other support body.

The protective film may not be disposed in any one of the examples illustrated in FIGS. 2A-2C. In addition, if bonding of the display panel PNL and the cover member CG is unnecessary, the adhesive AD may not be disposed. The third and fourth electrodes (not shown) constituting the sensor SE are formed on the same plane as the electrode groups EG.

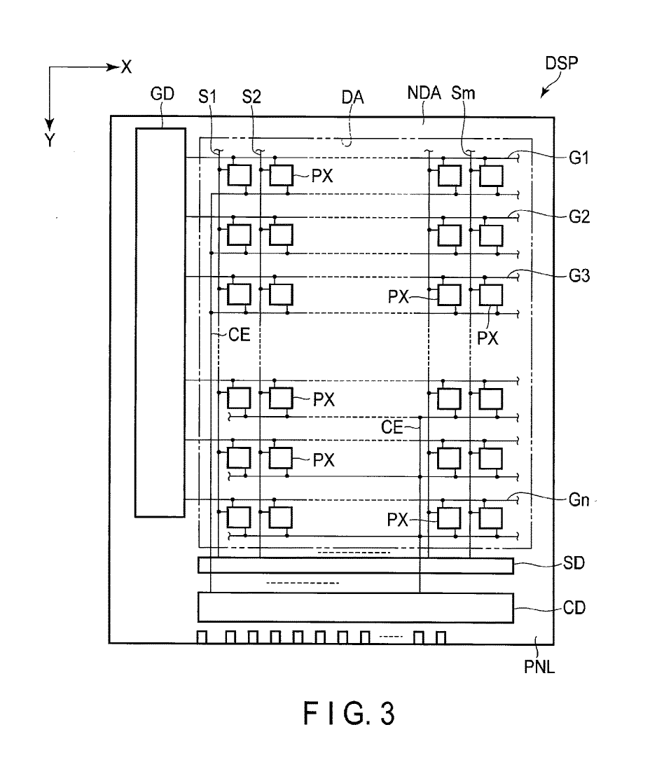

FIG. 3 is a diagram showing a basic configuration and an equivalent circuit, of the display panel PNL shown in FIG. 1.

The display panel PNL includes pixels PX in the display area DA. The pixels PX are arrayed in a matrix in the first direction X and the second direction Y. The display panel PNL includes scanning lines G (G1 to Gn), signal lines S (S1 to Sm), a common electrode CE and the like, in the display area DA. The scanning lines G extend in the first direction X to be arranged in the second direction Y. The signal lines S extend in the second direction Y to be arranged in the first direction X. The scanning lines G and the signal lines S may not extend linearly, but part of the lines may be bent. The common electrode CE is disposed over the pixels PX.

The display panel PNL includes a signal line drive circuit SD, a scanning line drive circuit GD, a common electrode drive circuit CD and the like, in a non-display area NDA. The signal line drive circuit SD, the scanning line drive circuit GD, and the common electrode drive circuit CD may be formed on the first substrate SUB1 or plural parts or entire bodies of the circuits may be built in the driving IC chip IC1. The layout of the drive circuits is not limited to the examples illustrated but, for example, the scanning line drive circuits GD may be disposed on both sides of the display area DA to sandwich the display area DA.

The scanning lines G are drawn to the non-display area NDA and connected to the scanning line drive circuit GD. The signal lines S are drawn to the non-display area NDA and connected to the signal line drive circuit SD. The common electrode CE is drawn to the non-display area NDA and connected to the common electrode drive circuit CD.

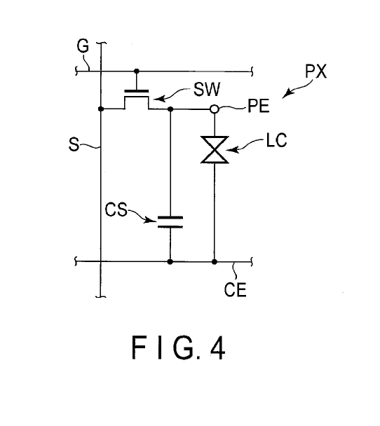

FIG. 4 is an equivalent circuit diagram showing one of pixels PX shown in FIG. 3.

Each pixel PX includes a switching element SW, a pixel electrode PE, the common electrode CE, a liquid crystal layer LC and the like. The switching element SW is composed of, for example, a thin film transistor (TFT). The switching element SW is electrically connected with the scanning line G and the signal line S. The pixel electrode PE is electrically connected with the switching element SW. The pixel electrode PE is opposed to the common electrode CE, and drives the liquid crystal layer LQ by an electric field formed between the pixel electrode PE and the common electrode CE. A storage capacitor CS is formed, for example, between the common electrode CE and the pixel electrode PE.

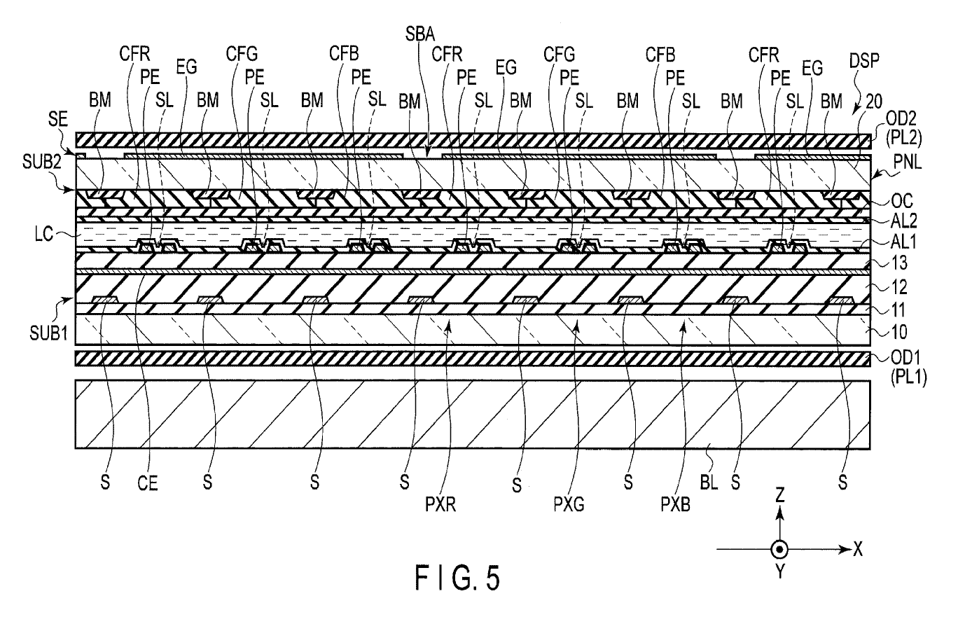

FIG. 5 is a cross-sectional view schematically showing a structure of a part of the display panel PNL shown in FIG. 1. FIG. 5 illustrates a cross-section of the display device DSP seen along the first direction X. The illustrated display panel PNL is configured to mainly correspond to a display mode using a lateral electric field which is substantially parallel to the main substrate surface but is not particularly limited, and may be configured to correspond to a display mode using a longitudinal electric field perpendicular to the main surface of the substrate, an oblique electric field inclined to the main substrate surface or a combination of the electric fields. In the display mode using the lateral electric field, for example, a configuration in which both the pixel electrodes PE and common electrode CE are disposed on the first substrate SUB1 can be employed in the display panel. In the display mode using the longitudinal electric field or the oblique electric field, for example, a configuration in which the pixel electrode PE is disposed in the first substrate SUB1 and the common electrode CE is disposed in the second substrate SUB2 can be employed in the display panel. The main surface of the substrate is a surface which is parallel to an X-Y plane defined by the first direction X and the second direction Y orthogonal to each other.

The first substrate SUB1 is formed based on a first insulating substrate 10 having a light transmitting property such as a glass substrate or a resin substrate. The first substrate SUB1 includes the signal lines S, the common electrode CE, the pixel electrodes PE, a first insulating film 11, a second insulating film 12, a third insulating film 13, a first alignment film AL1 and the like, on a side of the first insulating substrate 10 which is opposed to the second substrate SUB2. It should be noted that the switching elements, scanning lines, various insulating films interposed and the like are not illustrated in FIG. 5.

The signal lines S are formed on the first insulating film 11. The second insulating film 12 is disposed on the signal lines S and the first insulating film 11. The common electrode CE is formed on the second insulating film 12. The common electrode CE is formed on the entire surface of the second insulating film 12 in the example illustrated, but may be removed partially or divided into segments. The third insulating film 13 is disposed on the common electrodes CE and the second insulating film 12. The pixel electrodes PE are formed on the third insulating film 13. Each of the pixel electrodes PE is opposed to the common electrode CE via the third insulating film 13. Furthermore, each pixel electrode PE has a slit SL at a position opposed to the common electrode CE. The common electrode CE and the pixel electrodes PE are formed of a transparent conductive material such as indium-tin-oxide (ITO) or indium-zinc-oxide (IZO). The first alignment film AL1 covers the pixel electrodes PE and the third insulating film 13.

The pixel electrodes PE may be located between the second insulating film 12 and the third insulating film 13 while the common electrode CE may be located between the third insulating film 13 and the first alignment film AL1. In this case, the pixel electrodes PE are formed in a plate shape including no slit in each pixel, and the common electrode CE includes slits opposed to the pixel electrodes PE.

The pixel electrodes PE and the common electrode CE may be located on the same layer or, for example, may be located between the third insulating film 13 and the first alignment film AL1.

The second substrate SUB2 is formed by using a second insulating substrate 20 having a light transmitting property such as a glass substrate or a resin substrate. The second substrate SUB2 includes a light-shielding layer BM, color filters CFR, CFG and CFB, an overcoat layer OC, a second alignment film AL2 and the like, on a side of the second insulating substrate 20 which is opposed to the first substrate SUB1.

The light-shielding layer BM is formed at positions which section the pixels and are opposed to the signal lines S in FIG. 5. The color filters CFR, CFG, and CFB are formed at the positions opposed to the pixel electrodes PE, respectively, and are partially overlaid on the light-shielding layer BM. The color filter CFR is a red color filter, which is disposed on a pixel PXR exhibiting red color. The color filter CFG is a green color filter, which is disposed on a pixel PXG exhibiting green color. The color filter CFB is a blue color filter, which is disposed on a pixel PXB exhibiting blue color. A pixel exhibiting an other color such as white color may be further added. The overcoat layer OC covers the color filters CFR, CFG, and CFB. The second alignment film AL2 covers the overcoat layer OC.

The color filters CFR, CFG and CFB may be disposed on the first substrate SUB1. Alternatively, two or more color filters of different colors may be overlaid instead of disposition of the light-shielding layer BM, to lower the transmittance and function as light-shielding layers. A white color filter or an uncolored resin material may be disposed on the pixel exhibiting white color or the overcoat layer OC may be disposed without the color filters.

In the example illustrated, the electrode groups EG constituting the sensor SE are formed on the outer surface SBA of the second substrate SUB2. Such an electrode group EG is formed of, for example, a transparent conductive material such as ITO or IZO. The transparent conductive material is not particularly limited to the oxide material, but may be formed of a conductive organic material, a dispersing element of a fine conductance substance or the like.

The first optical element OD1 including a first polarizer PL1 is disposed between the first insulating substrate 10 and the illuminating unit BL. A second optical element OD2 including the second polarizer PL2 is disposed at a position opposed to the sensor SE. Each of the first optical element OD1 and the second optical element OD2 may include a retardation film as needed. The first polarizer PL1 and the second polarizer PL2 are disposed to be, for example, in a cross-Nicol positional relationship in which absorption axes of the respective polarizers cross each other at right angles.

Next, a configuration example of the sensor SE built in the display device DSP of the embodiment will be explained. The sensor SE hereinafter explained is, for example, a capacitive sensor, which detects contact or approach of the object, based on the variation in electrostatic capacitance between a pair of opposed electrodes.

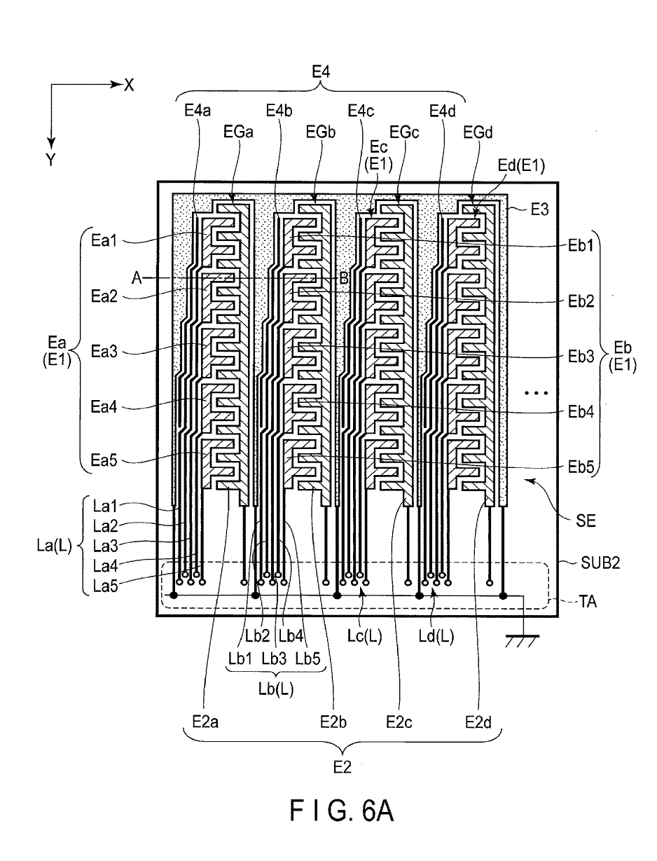

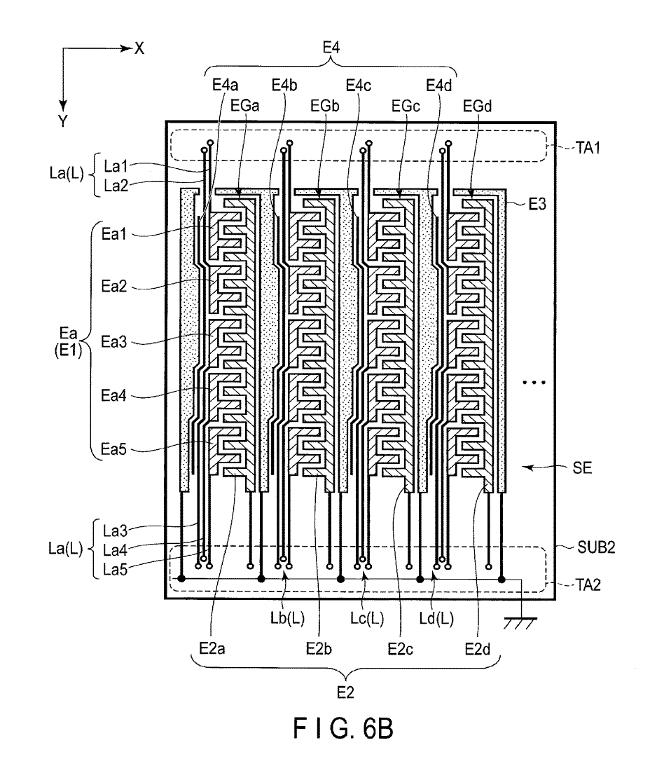

FIG. 6A is a plan view showing a configuration example of the sensor SE of the embodiment.

The sensor SE includes electrode groups EGa, EGb, EGc, EGd, . . . arranged in the first direction X. Each electrode group EG includes first electrodes E1, a second electrode E2 and connection lines L. In the example illustrated, the sensor SE includes a first electrode Ea corresponding to the electrode group EGa, a first electrode Eb corresponding to the electrode group EGb, a first electrode Ec corresponding to the electrode group EGc, and a first electrode Ed corresponding to the electrode group EGd, as the first electrodes E1. The sensor SE also includes a second electrode E2a corresponding to the electrode group EGa, a second electrode E2b corresponding to the electrode group EGb, a second electrode E2c corresponding to the electrode group EGc, and a second electrode E2d corresponding to the electrode group EGd, as the second electrodes E2. The sensor SE also includes a connection line La corresponding to the electrode group EGa, a connection line Lb corresponding to the electrode group EGb, a connection line Lc corresponding to the electrode group EGc, and a connection line Ld corresponding to the electrode group EGd, as the connection lines L.

Since configurations of the electrode groups EG are the same, the configuration of the electrode group EGa will be described in detail. The electrode group EGa includes the first electrodes Ea, the second electrode E2a and the connection lines La.

The first electrodes Ea include sensor elements Ea1, Ea2, Ea3, . . . arranged in the second direction Y and spaced apart from each other. In the example illustrated, each of the sensor elements Ea1, Ea2, Ea3, . . . is shaped in a letter F and includes two comb teeth extending in the first direction X. The second electrode E2a is disposed to be spaced apart from the sensor elements Ea1, Ea2, Ea3, . . . In the example illustrated, the sensor element E2a is shaped in a comb and includes comb teeth extending to the first electrodes Ea in the first direction X. The comb teeth of the second electrode E2a are disposed alternately with the comb teeth of the sensor elements Ea1, Ea2, Ea3, . . . The intervals between the first electrodes Ea and the second electrode E2a are substantially constant. The second electrode E2a extends to a terminal area TA located at an end portion of the second substrate SUB2 and is electrically connected to the flexible printed circuit FPC2 shown in FIG. 1.

The second electrode E2a may extend to a side different from the terminal area TA to be electrically connected to an other flexible printed circuit. Alternatively, the second electrode E2a may be led to a side different from the terminal area TA and extend to the terminal area TA via a routing line disposed in the non-display area NDA.

The connection lines La1, La2, La3, . . . are disposed on a side opposite to the second electrode E2a to sandwich the first electrodes Ea, and are electrically connected to the sensor elements Ea1, Ea2, Ea3, . . . , respectively. Each of the connection lines La1, La2, La3, . . . extends to the terminal area TA and is electrically connected to the flexible printed circuit FPC2. More specifically, the connection line La1 is joined to the end portion of the sensor element Ea1 and is arranged with the sensor element Ea2 and the connection line La2 to be spaced apart with substantially regular intervals. The connection line La2 is joined to the end portion of the sensor element Ea2 and is located between the sensor element Ea3 and the connection line La1 and between the connection line La1 and the connection line La3. In the example illustrated, since the sensor element Ea1, of the sensor elements constituting the first electrode Ea, is located farthest from the terminal area TA, the connection line La1 is the longest of the connection lines La and is located on an outermost side of the electrode group EGa. For example, the connection line La1 is longer than the connection line La2.

The terminal area TA is located at an end portion of the second substrate SUB2 in the example illustrated in FIG. 6A but is not limited to this case. In another configuration example illustrated in FIG. 6B, for example, terminal areas TA1 and TA2 are located at end portions of the second substrate SUB2, respectively. The terminal area TA2 is located on the side opposite to the terminal area TA1 to sandwich the area in which the sensor SE is located. The terminal areas TA1 and TA2 may be electrically connected to one flexible printed circuit or may be electrically connected to respective flexible printed circuits.

In the example illustrated in FIG. 6B, each of the connection lines La1 and La2 extends to the terminal area TA1. The connection line La1 is joined to the end portion of the sensor element Ea1. The connection line La2 is joined to the end portion of the sensor element Ea2 and is arranged with the sensor element Ea1 and the connection line La1 to be spaced apart from the sensor element and the connection line at substantially regular intervals. The connection line connected to the sensor element farthest from the terminal area TA1 (i.e., the connection line La2 connected with the sensor element Ea2 in the example illustrated), of the connection lines drawn to the terminal area TA1, is longest and is located on the outermost side of the electrode group.

Each of the connection lines La3 to La5 extends to the terminal area TA2. The connection line La3 is joined to the end portion of the sensor element Ea3 and is arranged with the sensor element Ea4 and the connection line La4 to be spaced apart from the sensor element and the connection line at substantially regular intervals. The connection line La4 is joined to the end portion of the sensor element Ea4 and is arranged with the sensor element Ea5 and the connection line La5 to be spaced apart from the sensor element and the connection line at substantially regular intervals. The connection line La5 is joined to the end portion of the sensor element Ea5. The connection line connected to the sensor element farthest from the terminal area TA2 (i.e., the connection line La3 connected with the sensor element Ea3 in the example illustrated), of the connection lines drawn to the terminal area TA2, is longest and is located on the outermost side of the electrode group.

The example will be explained again with reference to FIG. 6A. The electrode group EGb adjacent to the electrode group EGa also includes the first electrodes Eb, the second electrode E2b and the connection lines Lb. The first electrodes Eb includes sensor elements Eb1, Eb2, Eb3, . . . The second electrode E2b is disposed to be spaced apart from the sensor elements Eb1, Eb2, Eb3, . . . The connection lines Lb1, Lb2, Lb3, . . . are disposed on a side opposite to the second electrode E2b to sandwich the first electrodes Eb, and are electrically connected to the sensor elements Eb1, Eb2, Eb3, . . . , respectively.

In the embodiment, the sensor SE further includes a third electrode E3 disposed around each of the electrode groups EGa, EGb, EGc, EGd . . . , and fourth electrodes E4 disposed between the third electrode E3 and at least plural parts of the sensor elements and the connection lines of each of the electrode groups. The third electrode E3 functions as a shielding electrode which electrically shields each of the adjacent electrode groups. In the example illustrated, the third electrode E3 extends between two of the electrode groups EGa, EGb, EGc, EGd . . . , and is joined to the terminal area TA at the end portion of the opposite side. The intervals between the third electrode E3 and the electrode groups are substantially regular. When the adjacent electrode groups EGa and EGb are looked at, for example, the third electrode E3 is disposed between the second electrode E2a of the electrode group EGa, and the first electrodes Eb and connection lines Lb of the electrode group EGb. The third electrode E3 extends to the terminal area TA to be electrically connected to the flexible printed circuit FPC2. For example, the third electrode E3 is grounded. The third electrode E3 may not be grounded if the third electrode E3 is capable of exerting the function of the shielding electrode, and the electric potential of the third electrode E3 may be at an other fixed potential.

The third electrode E3 may extend to the terminal area TA2 to be electrically connected to the other flexible printed circuit, in the configuration example illustrated in FIG. 6B. Alternatively, the third electrode E3 may be drawn to a side different from the terminal area TA and extend to the terminal area TA via a routing line disposed in the non-display area NDA.

The fourth electrodes E4 function as dummy electrodes which suppress the coupling between the third electrode E3, and the sensor elements and the connection lines L of the first electrodes El. The intervals between the fourth electrodes E4 and the third electrode E3 are substantially regular, and the intervals between the fourth electrodes E4, and the sensor elements and the connection lines L are also substantially regular. The sensor SE includes a fourth electrode E4a corresponding to the electrode group EGa, a fourth electrode E4b corresponding to the electrode group EGb, a fourth electrode E4c corresponding to the electrode group EGc, and a fourth electrode E4d corresponding to the electrode group EGd, as the fourth electrodes E4.

In the configuration example illustrated in FIG. 6A, the fourth electrode E4a is located between the third electrode E3, and at least plural parts of the sensor element Ea1 and the connection line La1 of the first electrodes Ea. In the example illustrated, the fourth electrode E4a is arranged with the sensor element Ea1, and extends parallel to a middle portion of the connection line La1 (i.e., the position parallel with the sensor element Ea4). In the other fourth electrodes, also, for example, the fourth electrode E4b is located between the third electrode E3, and at least plural parts of the sensor element Eb1 and the connection line Lb1. Such a fourth electrode E4 is a floating electrode which is not electrically connected with any lines and signal sources.

As illustrated in FIG. 6A, the fourth electrodes E4 extend from the position arranged with the sensor element Ea1 farthest from the terminal area TA to the position arranged with the sensor element Ea4 next to the sensor element Ea5 closest to the terminal area TA, when the width in the first direction X of the fourth electrodes E4 is equal to the width in the first direction X of the connection line La. The fourth electrodes E4 can be therefore disposed without varying the width of the first direction X necessary to dispose the connection lines La1 to La5. For this reason, the fourth electrodes E4 can be disposed without varying the intervals between the adjacent electrode groups EG.

The positions at which the fourth electrodes E4 are disposed are not limited to those of the example illustrated. For example, the fourth electrodes E4 may not be definitely disposed at positions arranged with the sensor element Ea1 farthest from the terminal area TA. If space for disposing the fourth electrodes E4 can be sufficiently secured, the fourth electrodes E4 may be disposed at positions arranged with the sensor element Ea5 closest to the terminal area TA. The fourth electrodes E4 may be individually disposed at positions arranged with at least one of the sensor elements Ea1 to Ea5.

In the configuration example illustrated in FIG. 6B, the fourth electrode E4a is located between the third electrode E3, and at least plural parts of the sensor element Ea2 of the first electrodes Ea and the connection line La2 (i.e., the position arranged with the sensor element Ea1). In addition, the fourth electrode E4a is located between the third electrode E3, and at least plural parts of the sensor element Ea3 of the first electrodes Ea and the connection line La3 (i.e., the position arranged with the sensor elements Ea4 and Ea5). The other fourth electrodes are disposed similarly. The fourth electrode E4a extends to the position arranged with all the sensor elements Ea1 to Ea5, but is not limited to this example and may extend to the position arranged with, for example, the sensor elements Ea2 to Ea4.

In the examples illustrated in FIG. 6A and FIG. 6B, the width of the fourth electrodes E4 is equal to the width of the connection line La1 adjacent to the fourth electrodes E4, but the width of the fourth electrodes E4 may be increased to increase the intervals between the third electrode E3, and the sensor elements and the connection lines. By employing this manner, coupling between the third electrode E3, and the sensor elements and the connection lines can be further suppressed.

In the examples illustrated in FIG. 6A and FIG. 6B, one fourth electrode E4a is disposed as a floating electrode, between the sensor element Ea1 and the third electrode E3, but plural floating electrodes may be disposed instead. In this case, the lengths of the floating electrodes may be varied to prevent the width of the first direction X necessary for the connection lines from being varied. For example, a fourth electrode extending to the position arranged with the sensor elements Ea1 to Ea4, and a fourth electrode extending to the position arranged with the sensor elements Ea1 to Ea3, may be disposed as the floating electrodes.

Alternatively, a fourth electrode may be disposed between the second electrode E2a and the third electrode E3.

The above-described examples of the embodiment will be hereinafter explained.

The sensor SE includes:

a first electrode Ea including a first sensor element Ea1 and a second sensor element Ea2 disposed to be spaced apart from each other;

a second electrode E2a disposed to be spaced apart from the first sensor element Ea1 and the second sensor element Ea2;

a connection line La disposed on a side opposite to the second electrode E2a to sandwich the first electrode Ea, and including a first line La1 electrically connected to the first sensor element Ea1 and a second line La2 electrically connected to the second sensor element Ea2, the first line La1 arranged to be spaced apart from the second sensor element Ea2 and the second line La2;

a third electrode E3 disposed around an electrode group EGa including the first electrode Ea, the second electrode E2a and the connection line La; and

a fourth electrode E4a disposed between the third electrode E3, and at least plural parts of the first sensor element Ea1 and the first line La1.

In addition, the sensor includes:

a first electrode E1 including a first sensor element Ea1 and a second sensor element Eb1 disposed to be spaced apart from each other;

a second electrode E2a disposed between the first sensor element Ea1 and the second sensor element Eb1, on a side closer to the first sensor element Ea1;

a first line La1 disposed on a side opposite to the second electrode E2a to sandwich the first sensor element Ea1, and electrically connected to the first sensor element Ea1;

a second line Lb1 disposed on a side opposed to the second element E2a, and electrically connected to the second sensor element Eb1;

a third electrode E3 disposed between the second electrode E2a, and the second sensor element Eb1 and the second line Lb1; and

a fourth electrode E4b disposed between the third electrode E3, and at least plural parts of the second sensor element Eb1 and the second line Lb1.

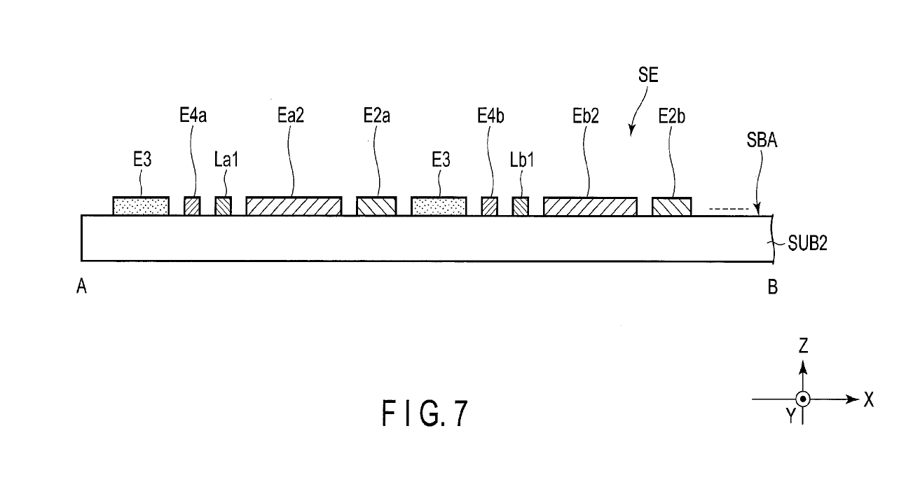

FIG. 7 is a cross-sectional view showing the sensor SE seen along line A-B of FIG. 6A.

The sensor SE is formed on the same plane of the second substrate SUB2 serving as a support body. The third electrode E3, the fourth electrode E4a, the connection line La1, the sensor element Ea2 of the first electrode Ea, the second electrode E2a, the third electrode E3, the fourth electrode E4b, the connection line Lb1, the sensor element Eb2 of the first electrode Eb, the second electrode E2b, . . . , which constitute the sensor SE, are arranged in order in the first direction X and spaced apart.

In this configuration example, the fourth electrode E4 is desirably formed of the same material as the other electrodes and the like formed on the same surface. In the examples illustrated in FIG. 6A and FIG. 7, the fourth electrodes E4 are desirably formed of the same material as the connection lines L and having an equal width. It should be noted that the first to fourth electrodes and the connection lines illustrated in FIG. 7 are formed of the same material, for example, a transparent, electrically conductive material such as ITO or IZO.

The electrode intervals are substantially equal. For example, the electrode intervals are desirably set to be as small as possible while securing the electric insulation between the adjacent electrodes. This can reduce the area of exposure of the second substrate SUB2 over the entire area in which the sensor SE is disposed. In particular, in the space between the adjacent electrode groups, the area of exposure of the second substrate SUB2 can be reduced by covering the space as much as possible by the third electrode E3. Thus, the pattern of the sensor SE overlaid on the display area DA can hardly be recognized visually and the degradation in display quality of the images displayed in the display area DA can be suppressed. In addition, the resistance of the third electrode E3 can be reduced by increasing the area for disposing the third electrode E3. In contrast, even if the electrode intervals are reduced, coupling between the third electrode E3 and the electrode groups can be suppressed since the fourth electrodes E4 are disposed between the third electrode E3 and the electrode groups.

Next, detecting (sensing) the object by the sensor SE of the embodiment will be explained. In each of the electrode groups, the first electrodes E1 or the second electrodes E2 are drive electrodes to which sensor drive signals necessary for sensing are transmitted while the others of the first electrodes E1 or the second electrodes E2 are detection electrodes which generate detection signals in accordance with the transmission of the sensor drive signals to the drive electrodes.

For example, in the electrode group EGa, the first electrodes Ea are drive electrodes while the second electrode E2a is the detection electrode. The detection circuit RC illustrated in FIG. 1 transmits the sensor drive signal to the sensor element Ea1 via the connection line La1 and receives the detection signal which has been generated together with the transmission of the sensor drive signal from the second electrode E2a. Similarly, the detection circuit RC sequentially transmits the sensor drive signals to the sensor elements Ea2, Ea3, Ea4, Ea5, . . . and receives the detection signal from the second electrode E2a. The detection circuit RC also performs the same sensing for the other electrode groups EGb, EGc, EGd . . . Simultaneously with supplying the sensor drive signal to the sensor element Ea1, the sensor drive signals are transmitted to the other sensor elements such as the sensor element Eb1 on the same line as the sensor element Ea1, and the detection signals can be received from the second electrodes opposed to the respective sensor elements. In this case, the other sensor elements on the same line as the sensor element Ea1 may be electrically connected to each other on, for example, the flexible printed circuit FPC2 or the like. For example, the detection circuit RC performs sensing a screen at approximately 15 ms (60 Hz).

The other sensing case in which the second electrode E2a of the electrode group EGa is a drive electrode and the first electrodes Ea are detection electrodes will be explained. The detection circuit RC transmits the sensor drive signal to the second electrode E2a, and receives the detection signal which has been generated together with the transmission of the sensor drive signal, from the second electrode E2a via the connection line La1. Similarly, the detection circuit RC also receives the detection signals from the sensor elements Ea2, Ea3, Ea4, Ea5, . . . The detection circuit RC also performs the same sensing for the other electrode groups EGb, EGc, EGd . . . Simultaneously with supplying the sensor drive signal to the second electrode E2a, the sensor drive signals are transmitted to the other second electrodes E2, and the detection signals can be received from the sensor elements of the first electrodes opposed to the respective second electrodes. In this case, the second electrodes E2 may be electrically connected to each other on, for example, the flexible printed circuit FPC2 or the like.

The configuration of the sensor SE is not limited to the above-explained example. For example, the sensor SE may not only be a mutual-capacitive sensor capable of detecting the object, based on the variation in electrostatic capacitance between paired electrodes (in the above example, the electrostatic capacitance between the first electrodes E1 and the second electrodes E2), but also a self-capacitive sensor capable of detecting the object, based on the variation in electrostatic capacitance of each sensor element in the first electrodes E1.

According to the embodiment, the sensor SE includes the third electrode E3 disposed around the electrode groups EG configured to detect the object. For this reason, the adjacent electrode groups EG are electrically shielded and the detection signals from the detection electrodes hardly receive influence from the sensor drive signals transmitted to the drive electrodes of the adjacent electrode groups.

In addition, the sensor SE further includes fourth electrodes E4 disposed between the third electrode E3 and at least plural parts of the sensor elements of the first electrodes E1 and the connection lines L. For this reason, a distance sufficient to suppress the coupling between the third electrode E3 which shields the electrode groups EG, and the sensor elements and the connection lines L can be secured. Thus, the load capacitance between the third electrode E3 and the connection lines L can be reduced, and degradation in the detection signals received via the connection lines L or the sensor drive signals transmitted via the connection lines L can be suppressed. The degradation in detection sensitivity can be therefore suppressed in the sensor SE.

In addition, the first electrodes E1, the second electrodes E2, the third electrode E3, the fourth electrodes E4, and the connection lines L are formed on the same surface of the support body, and the fourth electrodes E4 are formed of the same material as at least the first electrodes E1, the second electrodes E2, the third electrode E3 or the connection lines L. For this reason, the fourth electrodes E4 can be formed together in the same manufacturing process as at least the first electrodes E1, the second electrodes E2, the third electrode E3 or the connection lines L. Thus, manufacturing processes do not need to be increased and the manufacturing costs can be reduced, besides the above-described advantages. In particular, if all the first electrodes E1, the second electrodes E2, the third electrode E3 the fourth electrodes E4 and the connection lines L are formed of the same material, the manufacturing costs can be further reduced.

The fourth electrodes E4 are floating electrodes. For this reason, terminals or circuits to supply the electric potential to the fourth electrodes E4 do not need to be added.

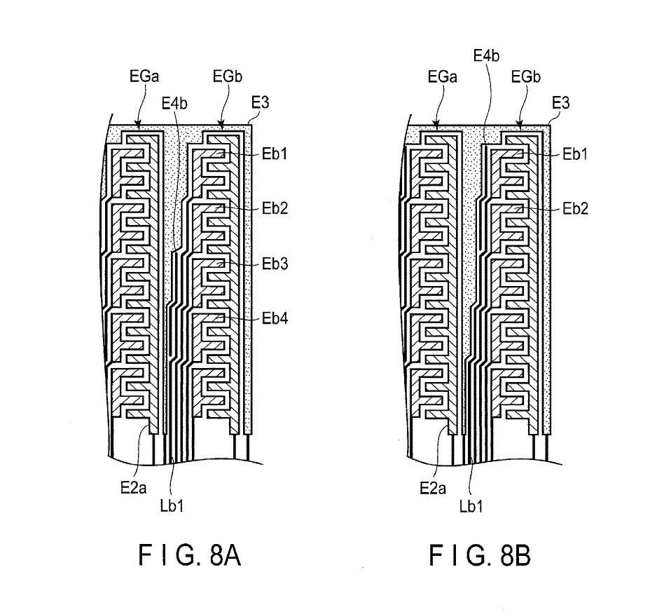

FIGS. 8A, 8B are illustrations showing examples of disposition of the fourth electrode E4. The adjacent electrode groups EGa and EGb are focused here.

In the example illustrated in FIG. 8A, the fourth electrode E4b corresponding to the electrode group EGb is disposed only at a position arranged with the sensor elements Eb3 and Eb4, in the area between the third electrode E3 and the connection line Lb1. In the example illustrated in FIG. 8B, the fourth electrode E4b is disposed only at a position arranged with the sensor element Eb2, in the area between the third electrode E3 and the sensor element Eb1 and between the third electrode E3 and the connection line Lb1. In either of the examples of FIG. 8A and FIG. 8B, the length of the fourth electrode E3b is the same, but the coupling suppression effect is higher in the example of FIG. 8B than that in the example of FIG. 8A. This occurs for the following reason. Each of the first electrodes Ea is wider than each of the connection lines L. For this reason, the capacitance generated between the first electrode Ea and the third electrode E3 is larger than the capacitance generated between the connection line L and the third electrode E3. A high coupling suppression effect can be obtained by disposing the fourth electrode E4 between the third electrode E3 and the first electrode Eb1 which can generate larger capacitance.

In addition, a high coupling suppression effect can be obtained by disposing the fourth electrode E4 having a greater length if sufficient space to dispose the fourth electrodes E4 can be secured.

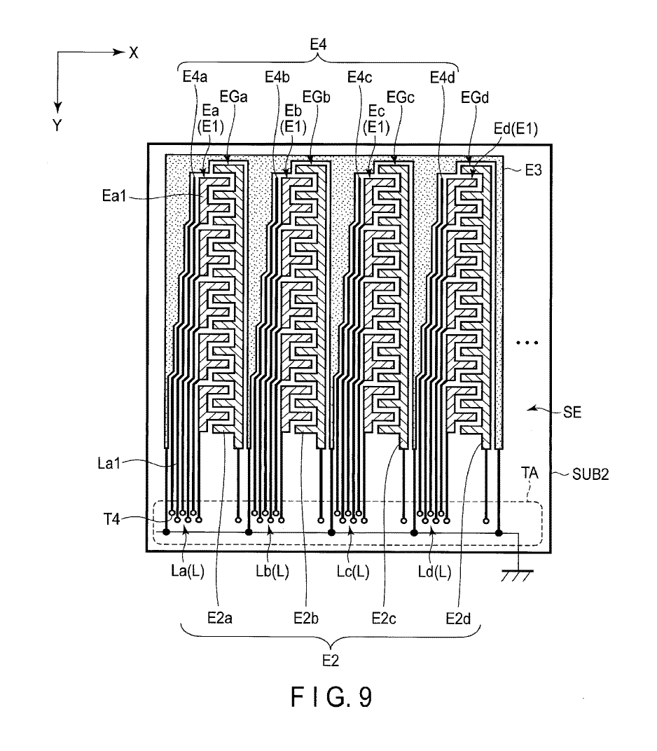

FIG. 9 is a plan view showing yet another configuration example of the sensor SE of the embodiment. The example illustrated is different from the example shown in FIG. 6A with respect to a feature that the potentials of the fourth electrodes E4 are fixed potentials. All the fourth electrodes E4a, E4b, E4c, E4d . . . extend to the terminal area TA. When the electrode group EGa is looked at, the fourth electrode E4a extends parallel to the entire body of the connection line La1 from the position arranged with the sensor element Ea1 to the connection line La1. The fourth electrode E4a includes a terminal T4 which is connected to the line of fixed potential in the terminal area TA. The fourth electrodes E4 can be electrically connected with the flexible printed circuit FPC2 in the terminal area TA, and can be supplied with a predetermined potential (for example, the same potential as the electric potential of the connection lines adjacent to the fourth electrode E4 and the sensor elements) via the flexible printed circuit FPC2. As an example of supplying a predetermined potential to the fourth electrodes E4, the same sensor drive signals as those transmitted to the first electrodes E1 may be transmitted to the fourth electrodes E4 if the first electrodes E1 are the drive electrodes. Thus, the sensor elements of the first electrodes E1, the connection lines L, and the fourth electrodes E4 come to the same potential, and thus coupling with the third electrode E3 can be further suppressed.

In the embodiment, the sensor elements of the first electrodes E1 are shaped in a letter F, but the shape of the sensor elements is not limited to this. For example, each sensor element may include at least three comb teeth extending in the first direction X. Alternatively, the sensor element may be formed in an other shape, for example, a star or a letter X.

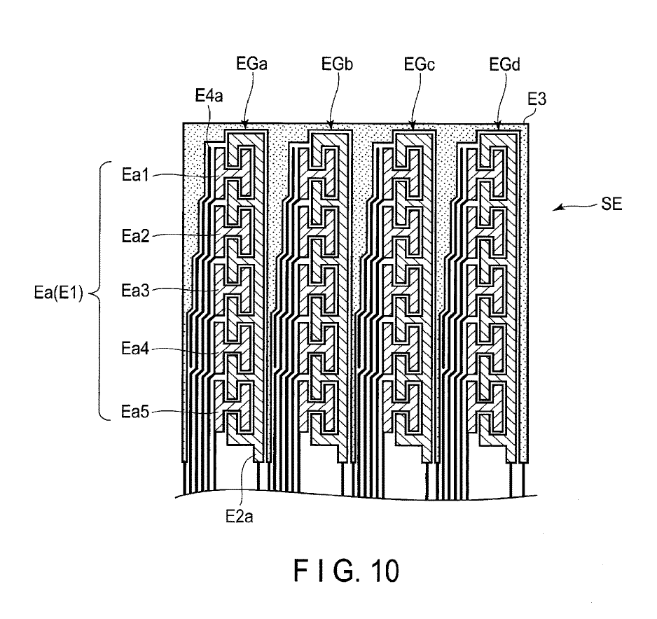

FIG. 10 is a plan view showing yet another configuration example of the sensor SE of the embodiment. The example illustrated is different from the example shown in FIG. 6A with respect to a feature that each of the sensor elements of the first electrodes E1 is shaped in a letter H. When the electrode group EGa is looked at, each of the sensor elements Ea1, Ea2, Ea3, . . . of the first electrode Ea is shaped in a letter H. The second electrode E2a is disposed to be spaced apart from the sensor elements Ea1, Ea2, Ea3, . . . The electrostatic capacitance between the first electrodes E1 and the second electrodes E2 depends on the length of the area in which the sensor elements and the second electrodes are opposed to be spaced apart at substantially regular intervals. In other words, if larger electrostatic capacitance is required, the shapes of the sensor elements and the second elements can be arbitrarily selected to increase the length of the area in which the sensor elements and the second elements are opposed.

In this configuration example, too, the same advantages as those of the above-described examples can be obtained.

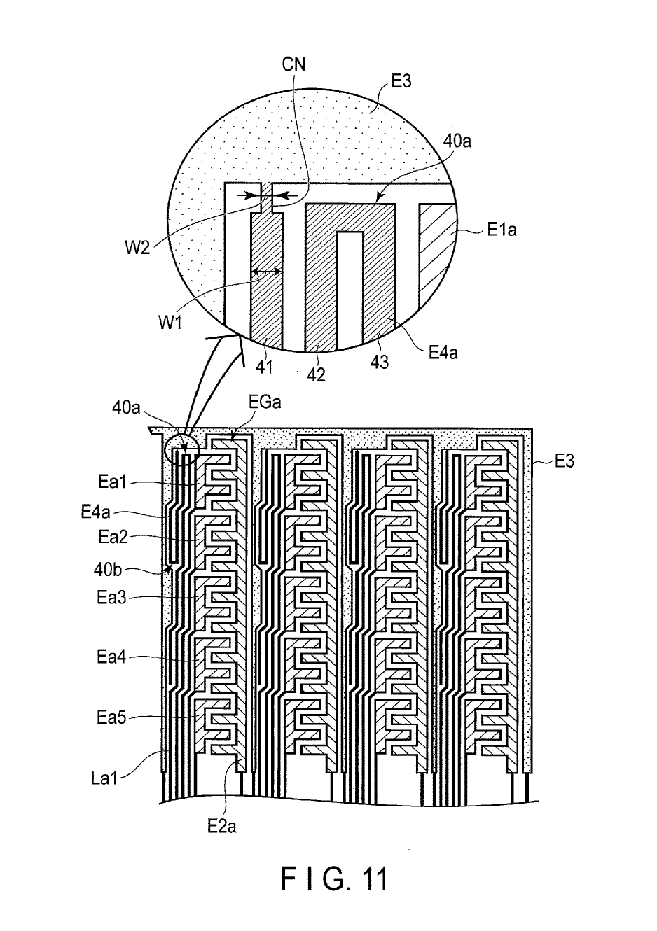

FIG. 11 is a plan view showing yet another configuration example of the sensor SE of the embodiment. The example illustrated is different from the example shown in FIG. 6A with respect to features that the fourth electrodes E4 are electrically connected with the third electrodes E3 and that the fourth electrodes E4 include turning portions. In other words, when the electrode group EGa is looked at, an end side of the fourth electrode E4a is joined to the third electrode E3. The other end side of the fourth electrode E4a may be electrically connected to the third electrode E3, the flexible printed circuit FPC2 and the like. In this configuration example, the fourth electrodes E4 are, desirably, integrally formed of the same material as the third electrode E3.

Charge of the fourth electrodes E4 can be thereby suppressed. In particular, in the configuration in which the sensor SE is opposed to the display panel PNL at a close position, an undesired electric field may be applied to the liquid crystal layer LC and the alignment failure of the liquid crystal molecules may occur, due to the charge of the fourth electrodes E4. According to the present configuration example of FIG. 11, the alignment failure of the liquid crystal molecules can be suppressed since the charge of the fourth electrodes E4 can be suppressed, even if the sensor SE is disposed closely to the display panel PNL. The deterioration in display quality can be therefore suppressed.

In addition, the fourth electrode E4a has a first width W1 which is substantially constant along the entire body. A connection portion CN of the third electrode E3 and the fourth electrode E4a has a second width W2 smaller than the first width W1. Each fourth electrode E4 includes at least one turning portion and has the line length increased. In the example illustrated of FIG. 11, the fourth electrode includes two turning portions 40a and 40b, and also includes a first portion 41, a second portion 42, and a third portion 43 which are arranged between the third electrode E3 and the sensor elements Ea1 and Ea2. The first to third portions 41 to 43 are arranged to be spaced apart with substantially regular intervals. The fourth electrode E4a may include one turning portion or at least three turning portions.

In this configuration example of FIG. 11, the fourth electrodes E4 are electrically connected with the third electrode E3 via high-resistance components. For this reason, since the high-resistance fourth electrodes E4 are interposed between the sensor elements of the first electrodes E1 and the connection lines L, and the third electrode E3, the coupling can be suppressed. In addition, when the resistance of the fourth electrodes E4 is increased, the pattern of the sensor SE can hardly be visually recognized by setting the first width W1 of the electrodes to be substantially constant and also setting the intervals between the adjacent first to third portions 41 to 43 to be substantially constant.

As described above, the liquid crystal display device capable of suppressing the deterioration in display quality can be provided according to the embodiments.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sensor comprising:
a first electrode including a first sensor element and a second sensor element disposed to be spaced apart from each other;
a second electrode disposed to be spaced apart from the first sensor element and the second sensor element;
a connection line disposed on a side opposite to the second electrode to sandwich the first electrode, the connection line including a first line electrically connected to the first sensor element and a second line electrically connected to the second sensor element, the first line arranged to be spaced apart from the second sensor element and the second line;
a third electrode disposed around an electrode group including the first electrode, the second electrode, and the connection line; and
a fourth electrode disposed between the third electrode, and at least plural parts of the first sensor element and the first line.

2. The sensor of claim 1, further comprising a support body,
wherein the first electrode, the second electrode, the third electrode, the fourth electrode, and the connection line are formed on a same surface of the support body.

3. The sensor of claim 1, wherein
the fourth electrode is formed of a same material as a material of at least one of the first electrode, the second electrode, the third electrode, and the connection line.

4. The sensor of claim 1, wherein
the first line is longer than the second line.

5. The sensor of claim 1, wherein
one of the first electrode and the second electrode is a drive electrode to which a sensor drive signal is transmitted, and
the other of the first electrode and the second electrode is a detection electrode which generates a detection signal as the sensor drive signal is transmitted to the drive electrode.

6. The sensor of claim 1, wherein
the fourth electrode is a floating electrode.

7. The sensor of claim 1, wherein
an electric potential of the fourth electrode is a fixed potential.

8. The sensor of claim 1, wherein
the third electrode is grounded.

9. The sensor of claim 1, wherein
the fourth electrode is electrically connected with the third electrode.

10. The sensor of claim 9, wherein
the fourth electrode has a first width, and
a connection portion of the third electrode and the fourth electrode has a second width smaller than the first width.

11. The sensor of claim 1, wherein
the fourth electrode includes a turning portion.

12. A display device comprising:
a display panel including a display area to display an image;
a cover member opposed to the display panel; and
a sensor disposed on any one of a side of the display panel opposed to the cover member, an inner side of the display panel, or a side of the cover member opposed to the display panel;
the sensor comprising:
a first electrode including a first sensor element and a second sensor element disposed to be spaced apart from each other;
a second electrode disposed to be spaced apart from the first sensor element and the second sensor element;
a connection line disposed on a side opposite to the second electrode to sandwich the first electrode, the connection line including a first line electrically connected to the first sensor element and a second line electrically connected to the second sensor element, the first line disposed to be spaced apart from the second sensor element and the second line;
a third electrode disposed around an electrode group including the first electrode, the second electrode and the connection line; and
a fourth electrode disposed between the third electrode, and at least plural parts of the first sensor element and the first line.

13. The display device of claim 12, wherein the display panel or the cover member comprises a support body, and
the first electrode, the second electrode, the third electrode, the fourth electrode, and the connection line are formed on a same surface of the support body.

14. The display device of claim 12, wherein
the fourth electrode is formed of a same material as a material of at least one of the first electrode, the second electrode, the third electrode, and the connection line.

15. The display device of claim 12, wherein
the first line is longer than the second line.

16. The display device of claim 12, wherein
one of the first electrode and the second electrode is a drive electrode to which a sensor drive signal is transmitted, and
the other of the first electrode and the second electrode is a detection electrode which generates a detection signal, simultaneously with transmission of the sensor drive signal to the drive electrode.

17. The display device of claim 12, wherein the fourth electrode is a floating electrode.

18. The display device of claim 12, wherein an electric potential of the fourth electrode is a fixed potential.

19. The display device of claim 12, wherein the third electrode is grounded.

20. The display device of claim 12, wherein the fourth electrode is electrically connected with the third electrode.

21. The display device of claim 20, wherein
the fourth electrode has a first width, and
a connection portion of the third electrode and the fourth electrode has a second width smaller than the first width.

22. The display device of claim 12, wherein
the fourth electrode includes a turning portion.

23. A sensor comprising:
a first electrode including a first sensor element and a second sensor element disposed to be spaced apart from each other;
a second electrode disposed between the first sensor element and the second sensor element, on a side closer to the first sensor element;
a first line disposed on a side opposite to the second electrode to sandwich the first electrode, and electrically connected to the first sensor element;
a second line disposed on the side opposite to the second electrode and electrically connected to the second sensor element;
a third electrode disposed between the second electrode, and the second sensor element and the second line; and
a fourth electrode disposed between the third electrode, and at least plural parts of the second sensor element and the second line.

24. A display device comprising:
a display panel including a display area to display an image;
a cover member opposed to the display panel; and
a sensor disposed on any one of a side of the display panel opposed to the cover member, an inner side of the display panel, or a side of the cover member opposed to the display panel;
the sensor comprising:
a first electrode including a first sensor element and a second sensor element disposed to be spaced apart from each other;
a second electrode disposed between the first sensor element and the second sensor element, on a side closer to the first sensor element;
a first line disposed on a side opposite to the second electrode to sandwich the first electrode, and electrically connected to the first sensor element;
a second line disposed on the side opposite to the second electrode and electrically connected to the second sensor element;
a third electrode disposed between the second electrode, and the second sensor element and the second line; and
a fourth electrode disposed between the third electrode, and at least plural parts of the second sensor element and the second line.
